(19) United States
(12) Patent Application Publication
(10) Pub. No.: US 2021/0350129 A1
(43) Pub. Date: Nov. 11, 2021

(54) USING NEURAL NETWORKS FOR OBJECT DETECTION IN A SCENE HAVING A WIDE RANGE OF LIGHT INTENSITIES

(71) Applicant: Axis AB, Lund (SE)

(72) Inventors: Andreas MUHRBECK, Lund (SE); Anton JAKOBSSON, Lund (SE); Niclas SVENSSON, Lund (SE)

(21) Appl. No.: 17/224,610

(22) Filed: Apr. 7, 2021

(30) Foreign Application Priority Data
May 7, 2020 (EP) 20173368.0

(51) Int. Cl. G06K 9/00; G06N 3/08; G06T 7/90

(52) U.S. Cl. CPC G06K 9/00664; G06K 9/00825; G06T 7/90; G06N 3/08

(57) ABSTRACT

Methods and apparatus, including computer program products, for processing images recorded by a camera (202) monitoring a scene (200). A set of images (204, 206, 208) is received. The set of images (204, 206, 208) includes differently exposed images of the scene (200) recorded by the camera (202). The set of images (204, 206, 208) is processed by a trained neural network (210) configured to perform object detection, object classification and/or object recognition in image data, wherein the neural network (210) uses image data from at least two differently exposed images in the set of images (204, 206, 208) to detect objects in the set of images (204, 206, 208).

### BACKGROUND

The present invention relates to cameras, and more specifically to detecting, classifying and/or recognizing objects in High Dynamic Range (HDR) images.

Image sensors are commonly used in electronic devices such as cellular telephones, cameras, and computers to capture images. In a typical arrangement, an electronic device is provided with a single image sensor and a single corresponding lens. In certain applications, such as when acquiring still or video images of a scene with a large range of light intensities, it may be desirable to capture HDR images, in order not to lose data due to saturation (i.e., too bright) or due to low signal-to-noise ratio (i.e., too dark) of images captured with a conventional camera. By using HDR images, highlight and shadow detail can be retained that would otherwise be lost in a conventional image.

HDR imaging typically works by merging a short exposure and a long exposure of the same scene. Sometimes, more than two exposures can be involved. Since multiple exposures are captured by the same sensor, the exposures need to be captured at slightly different times, which can cause temporal problems in terms of motion artifacts, or ghosting. Another problem with HDR images is contrast artifacts, which can be a side-effect of tone mapping. Thus, while HDR is able to alleviate some of the problems relating to capturing images in high-contrast environments, it also introduces a different set of problems, which need to be addressed.

### SUMMARY

According to a first aspect, the invention relates to a method, in a computer system, for processing images recorded by a camera monitoring a scene. The method includes:
receiving a set of images, wherein the set of images includes differently exposed images of the scene recorded by the camera; and
processing the set of images by a trained neural network configured to perform one or more of: object detection, object classification, and object recognition in image data, wherein the neural network uses image data from at least two differently exposed images in the set of images to detect objects in the set of images.

This provides a way of improving techniques for detecting, classifying and/or recognizing objects in scenes where HDR imaging would conventionally be used, while at the same time avoiding common HDR image problems in the form of motion artifacts, ghosting and contrast artifacts, just to mention a few examples. By operating on a set of images received from a camera, rather than on a merged HDR image, the neural network will have access to more information and can more accurate detect, classify and/or recognize objects. The neural network can be extended with sub-networks, as needed. For example, in one implementation, there may be a neural network for detection and classification of objects, and another sub-network for recognizing objects, for example by referencing a database of known object instances. This makes the invention suitable in applications where the identity of an object or person in an image needs to be determined, such as in facial recognition applications, for example. The method can advantageously be implemented in a monitoring camera. This is beneficial, because when an image is transmitted from the camera, the image must be coded in a format that is suitable for transmission, and in this coding process there could be a loss of information that is useful for the neural network to detect and classify objects. Further, implementing the method in close proximity to the image sensor minimizes any latency in the event that adjustments need to be made to camera components, such as the image sensor, optics, PTZ motors, etc., to obtain better images. Such adjustments can be initiated by a user or can be automatically initiated by the system, in accordance with various embodiments.

According to one embodiment, processing the set of images may include processing only a luminance channel for each image. The luminance channel often contains sufficient information to allow for object detection and classification, and as a result other color space information in an image can be discarded. This both reduces the amount of data that needs to be transmitted to the neural network, and it also reduces the size of the neural network, since only one channel per image is used.

According to one embodiment, processing the set of images may include processing three channels for each image. This allows images that are coded in three color planes, such as RGB, HSV, YUV, etc., to be processed directly by the neural network, without having to do any type of pre-processing of the images.

According to one embodiment, the set of images may include three images having different exposure times. In many cases, cameras that produce HDR images use one or more sensors that capture images with varying exposure times. The individual images can be used as input to the neural network (rather than stitching them together into an HDR image). This may facilitate integration of the invention into existing camera systems.

According to one embodiment, the processing may be performed in the camera prior to performing further image processing. As was mentioned above, this is beneficial as it avoids any losses of data that may occur when images are processed to be transmitted from the camera.

According to one embodiment, the images in the set of images represent raw Bayer image data from an image sensor. As the neural network does not need to “view” an image, but operates on values, there are cases in which an image that can be viewed and understood by a person would not have to be created. Instead, the neural network can operate directly on the raw Bayer image data that is output from the sensor, which may even further improve the accuracy of the invention, as it removes yet another processing step before the image sensor data reaches the neural network.

According to one embodiment, training the neural network to detect objects can be done by feeding the neural network generated images of a known object depicted under varying exposure and displacement conditions. There are many publicly available image databanks that contain annotated images of known objects. These images can be manipulated, using conventional techniques, in ways that simulate what the incoming data from an image sensor to the neural network might look like. By doing so, and feeding these images to the neural network, along with information about what objects are depicted in the images, the neural network can be trained to detect objects that would be likely to occur in a scene captured by a camera. Furthermore, this training could be largely automated, which would increase the efficiency of the training.

According to one embodiment, the object may be a moving object. That is, the various embodiments of the invention can be applied not only to static objects, but also to moving objects, which increases the versatility of the invention.

According to one embodiment, the set of images may be a sequence of images having temporal overlap or temporal proximity, a set of images obtained from one or more sensors having different signal to noise ratio, a set of images having different saturation levels, and a set of images obtained from two or more sensors having different resolutions. For example, there may be several sensors having varying resolutions or varying sizes (a larger sensor receives more photons per unit area and is often more light sensitive). As another example, one sensor might be a “black-and-white” sensor, i.e., a sensor without a color filter, which would offer higher resolution and higher light sensitivity. As yet another example, in a two-sensor setup, one of the sensors could be twice as fast as the other one, and record two “short exposure images” while a “long exposure image” is recorded by the other one. That is, the invention is not limited to on any particular type of images, but can instead be adapted to whatever imaging situation is available at the scene of interest, as long as the neural network is trained for the same type of circumstances.

According to one embodiment, the objects may include one or more of: people, faces, vehicles, and license plates. These are objects that are commonly identified in scenes, and in applications where it is important to have accurate detection, classification, and recognition. Generally speaking, the methods described herein can be applied to any object that might be of interest for the specific use case at hand. Vehicles in this context can refer to any type of vehicles, such as cars, buses, mopeds, motorcycles, scooters, etc. just to mention a few examples.

According to a second aspect, the invention relates to a system for processing images recorded by a camera monitoring a scene. The memory contains instructions that when executed by the processor causes the processor to perform a method that includes:
receiving a set of images, wherein the set of images includes differently exposed images of the scene recorded by the camera; and
processing the set of images by a trained neural network configured to perform one or more of: object detection, object classification and object recognition in image data, wherein the neural network uses image data from at least two differently exposed images in the set of images to detect objects in the set of images.

The system advantages correspond to those of the method and may be varied similarly.

According to a third aspect, the invention relates to a computer program for processing images recorded by a camera monitoring a scene. The computer program contains instructions corresponding to the steps of:
receiving a set of images, wherein the set of images includes differently exposed images of the scene recorded by the camera; and
processing the set of images by a trained neural network configured to perform one or more of: object detection, object classification, and object recognition in image data, wherein the neural network uses image data from at least two differently exposed images in the set of images to detect objects in the set of images.

The computer program involves advantages corresponding to those of the method and may be varied similarly.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a flowchart showing a method for detecting and classifying objects in images recorded by a camera monitoring a scene, in accordance with one embodiment.

FIG. 2 is a schematic diagram showing a camera capturing a scene, and a neural network for processing the image data, in accordance with one embodiment.

Like reference symbols in the various drawings indicate like elements.

### DETAILED DESCRIPTION

### Overview

As was described above, a goal with the various embodiments of the invention is to provide improved techniques for detecting, classifying and/or recognizing objects in HDR imaging situations. The invention stems from the realization that Convolutional Neural Networks (CNNs), which can be trained to detect objects in images, also can be trained to detect objects in a set of images depicting the same scene, but being captured with different exposures, by treating the images in the set of images together. That is, the CNN can operate directly on the set of input images, rather than first having to create an HDR image and then detect objects in that HDR image, as is the case in conventional applications. As a result, a camera system cooperating with a specially designed and trained CNN, in accordance with the various embodiment described herein, is able to handle differing lighting conditions better than current systems that use an HDR camera together with a conventional CNN. Further, by using several images as opposed to a created HDR image, there is more data available upon which various types of image analyses can be made, which can lead to more accurate object detection, classification and recognition compared to conventional techniques. As was mentioned above, implementing the method in close proximity to the image sensor makes it possible to minimize any latency in the event that adjustments need to be made to camera components, such as the image sensor, optics, PTZ motors, etc., to obtain better images.

Training data for the CNN can be generated, for example, by applying noise models and digital gain or saturation, as well as movement for the object to simulate the object movement that might occur between different frames, to open datasets with annotated images, to achieve sets of images with different, artificially applied, exposure and movement of the object. As the skilled person realizes, the training can also be adapted for the particular surveillance situation at hand in the scene monitored by the camera. Various embodiments will now be described in further detail by way of example and with reference to the figures.

### Terminology

The following list of terms will be used below in describing the various embodiments.

Scene—a three-dimensional physical space whose size and shape is defined by the field of view of a camera recording the scene.

Object—a material thing that can be seen and touched. A scene typically includes one or more objects. Objects can be either stationary (e.g., buildings and other structures) or moving (e.g., vehicles). Objects, as used herein, also include people and other living organisms, such as animals, trees, etc. Objects can be divided into classes, based on common features that they share. For example, one class can be “cars;” another class can be “people;” yet another class can be “furniture,” and so on. Within each class, there can be subclasses at increasingly granular levels.

Convolution Neural Network (CNN)—a class of deep neural networks, most commonly applied to analyzing visual imagery. The CNN can ingest an input image, assign importance (learnable weights and biases) to various objects in the image and differentiate one object from another. CNNs are well known to those having ordinary skill in the art, and their inner workings will therefore not be defined in detail herein, but rather their applications in the context of the invention will be described below.

Object Detection—the process of using a CNN to detect one or more objects in an image (typically an image from a camera recording a scene). That is, the CNN answers the question “What does the captured image represent?” or more specifically, “Where in the image are there objects of classes (e.g., cars, cats, dogs, buildings, etc.)?”

Object Classification—the process of using a CNN to determine the class of one or more detected objects, but not the identity of the specific instance of the object. That is, the CNN answers questions such as “Is the detected dog in the image a Labrador or a Chihuahua?” or “Is the detected car in the image a Volvo or a Mercedes?”, but it cannot answer a question such as “Is this individual Anton, Niclas or Andreas?”

Object Recognition—the process of using a CNN to determine the identity of an instance of an object, typically through comparison with a reference set of unique object instances. That is, the CNN can compare an object classified as a person in an image with a set of known persons and determine a likelihood that “The person in this image is Andreas.”

### Detecting and classifying objects

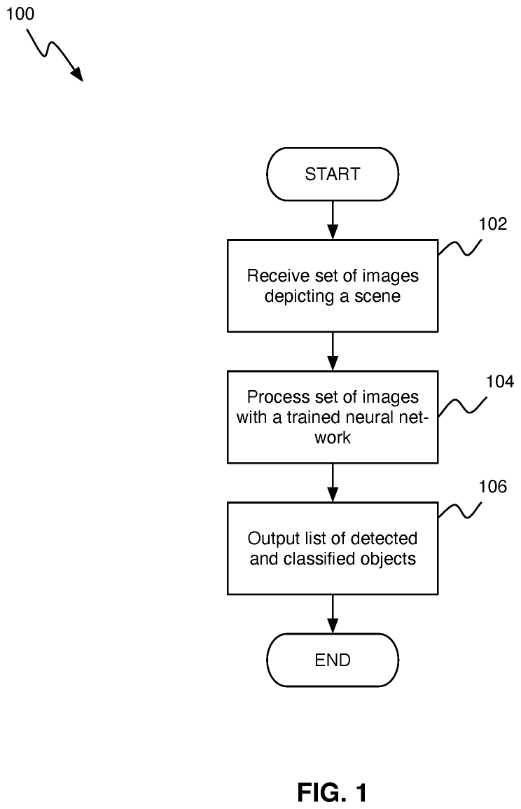

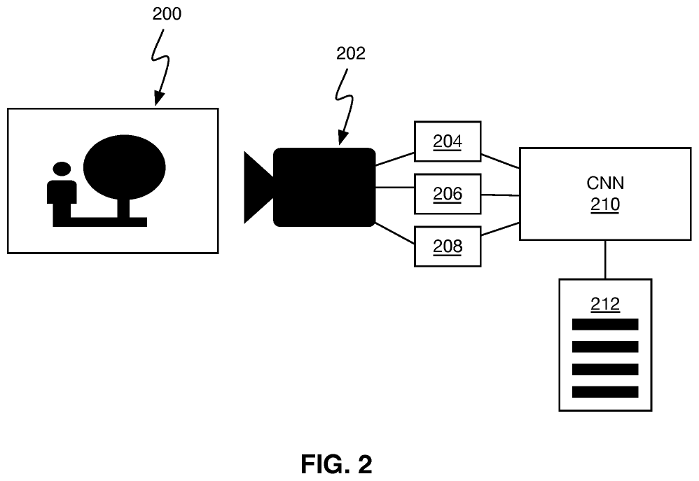

The following example embodiments illustrate how the invention can be used to detect and classify objects in a scene recorded by a camera. FIG. 1 is a flowchart showing a method 100 for detecting and classifying objects, in accordance with one embodiment. FIG. 2 schematically shows an environment in which the method can be implemented. The method 100 can be performed automatically, either continuously or at various intervals, as required by the particular monitoring scene, to efficiently detect and classify objects in a scene monitored by the camera.

As can be seen in FIG. 2, a camera 202 monitors a scene 200, in which a person is present. The method 100 begins by receiving images of the scene 200 from the camera 202, step 102. In the illustrated embodiment, three images 204, 206, and 208, respectively are received from the camera. These images all depict the same scene 200, but under varying exposure conditions. For example, image 204 can be a short exposure image, image 206 can be a medium exposure image, and image 208 can be a long exposure image. Typically, a conventional CMOS sensor can be used in the camera 202 to capture the images, as is well known to those having ordinary skill in the art. The images can be temporally close, that is, captured close in time to each other by a single sensor. The images can also be temporally overlapping, for example, if a camera uses dual sensors and, say, a short exposure image is captured while a long exposure image is being captured. Many variations can be implemented based on the specific circumstances at hand at the monitoring scene.

As is well known to those having ordinary skill in the art, images can be represented using a variety of color spaces, such as RGB, YUV, HSV, YCBCR, etc. In the implementation shown in FIG. 2, the color information in images 204, 206 and 208 is disregarded, and only information in the luminance channel (Y) for the respective images is used as an input to a CNN 210. Since the luminance channel contains all “relevant” information in terms of features that can be used to detect and classify objects, the color information can be discarded. Further, this reduces the number of tensors (i.e., inputs) of the CNN 210. For example, in the particular situation shown in FIG. 2, the CNN 210 can have three tensors, that is, the same number of tensors that would conventionally be used to process a single RGB image.

However, it should be realized that the general principles of the invention can be extended to essentially any color space. For example, in one implementation, instead of providing a single luminance channel for each of three images as input to the CNN 210, the CNN 210 can be fed with three RGB images, in which case the CNN 210 would need to have 9 tensors. That is, using RGB images as inputs would require a larger CNN 210, but the same general principles would still apply, and no major design changes to the CNN 210 would be needed compared to when only one channel per image is used.

This general idea can be even further extended, such that in some implementations there may not even be any need to interpolate the raw data (e.g., Bayer data) from the image sensor in the camera into an RGB representation for all pixels. Instead, the raw data itself from the sensor can serve as inputs to the tensors of the CNN 210, thereby moving the CNN 210 even closer to the sensor itself and further reducing data losses that may occur when converting sensor data into an RGB representation.

Next the CNN 210 processes the received image data to detect and classify objects, step 104. This can be done by, for example, feeding the different exposures in a concatenated manner (i.e., adding data in separate successive channels, e.g., r-long, g-long, b-long, r-short, g-short, b-short) to the CNN 210. The CNN 210 then has access to information taken with different exposures, thus forming a richer understanding of the scene. The CNN 210 then proceeds, by using trained convolutional kernels, to extract and process the data from the different exposures and, as a result, weigh in information from the best exposure(s). In order to process the image data in this manner, the CNN 210 must be trained to detect and classify objects based on the particular types of inputs that the CNN 210 receives. The pre-training of the CNN 210 will be described in the next section.

Finally, the results from the processing by the CNN 210 are output as a set 212 of classified objects in the scene, step 106, which ends the process. The set of classified objects 212 can be output in any form that will either allow review by a human user, or further processing by other system components, for example, to perform object recognition and similar tasks. Common applications include detecting and recognizing people and vehicles, but of course the principles described herein can be used to recognize any kind type of object that might appear in the scene 200 captured by the camera 202.

### Training the Neural Network

As was mentioned above, the CNN 210, must be trained before it can be used to detect and classify objects in images captured by the camera 202. Training data for the CNN 210 can be generated by using an open dataset of annotated images and applying various types of noise models and digital gain/saturation, as well as movement of the object, to the images in order to simulate conditions that might occur in a situation where an HDR camera conventionally would be employed. By having sets of images with artificially applied exposures and movements, while also knowing the “ground truth” (i.e., the type of object, such as face, license plate, human being, etc.) the CNN 210 can learn to detect and classify objects when receiving real HDR image data, as discussed above. In some embodiments, the CNN 210 is advantageously trained using noise models and digital gain/saturation parameters that would occur in real-world setup. Expressed differently, the CNN 210 is trained using an open dataset of images that is altered using specific parameters representative of the camera, image sensor, or system that will be used at the scene.

### Concluding Comments

It should be noted that while the embodiments above have been described with respect to images having short, medium and long exposure times, respectively, the same principles can be applied to essentially any type of varying exposures of a same scene. For example, different analog gain in the sensor may (typically) reduce the noise level in the readout from the sensor. At the same time, certain brighter parts of the scene are adjusted in ways that are similar to what occurs when the exposure time is prolonged. This results in different SNR and saturation levels in the images, which can be used in various implementations of the invention. Also, it should be noted that while the above method is preferably performed in the camera 202 itself, this is no requirement, and the image data can be sent from the camera 202 to another processing where the CNN 210 is located, along with possible further processing equipment.

While the techniques above have been described with respect to a single CNN 210, it should be realized that this is done only for purposes of illustration, and that in a real world implementation, the CNN may include several subsets of neural networks. For example, a backbone neural network can be used to find features (e.g., features indicating a “car” vs. features indicating a “face”). Another neural network can determine whether there are several objects within a scene (e.g., two cars and three faces). Yet another network can be added to determine which pixels in the image belong to which object, and so on. Thus, in an implementation where the above techniques are used for purposes of face recognition, there may be a number of subsets of neural networks. Accordingly, when referring to CNN 210 above, it should be clear that this may involve a number of neural networks.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Thus, many other variations that fall within the scope of the claims can be envisioned by those having ordinary skill in the art.

It should be noted, that while the implementations above have been described by way of example and with reference to a CNN, there can also be implementations that use other types of neural networks, or other types of algorithms, and achieve the same or similar results. Thus, other implementations also fall within the scope of the appended claims.

The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing images recorded by a camera monitoring a scene, the method comprising:
receiving a set of images, wherein the set of images includes a long exposure image and a short exposure image of the scene, wherein the long exposure image and the short exposure image are recorded by the camera at times that are close proximity or overlapping; and
processing the set of images by a trained neural network configured to perform one or more of: object detection, object classification and object recognition in image data, wherein the neural network uses image data from both the long exposure image and the short exposure image to detect objects in the set of images.

2. The method of claim 1, wherein processing the set of images includes processing only a luminance channel for each image.

3. The method of claim 1, wherein processing the set of images includes processing three channels for each image.

4. The method of claim 1, wherein the set of images includes three images having different exposure times.

5. The method of claim 1, wherein the processing is performed in the camera prior to performing further image processing.

6. The method of claim 1, wherein the images in the set of images represent raw Bayer image data from an image sensor.

7. The method of claim 1, further comprising:
training the neural network to detect objects by feeding the neural network generated images of a known object depicted under varying exposure and displacement conditions.

8. The method of claim 1, wherein the object is a moving object.

9. The method of claim 1, wherein the set of images is one of: a sequence of images having temporal overlap or temporal proximity, a set of images obtained from one or more sensors having different signal to noise ratio, a set of images having different saturation levels, and a set of images obtained from two or more sensors having different resolutions.

10. The method of claim 1, wherein the objects include one or more of: people, faces, vehicles, and license plates.

11. A system for processing images recorded by a camera monitoring a scene, comprising:
a memory; and
a processor,
wherein the memory contains instructions that when executed by the processor causes the processor to perform a method that includes:
receiving a set of images, wherein the set of images includes differently exposed images of the scene recorded by the camera; and
processing the set of images by a trained neural network configured to perform one or more of: object detection, object classification and object recognition in image data, wherein the neural network uses image data from at least two differently exposed images in the set of images to detect objects in the set of images.

12. A non-transitory computer readable storage medium having program instructions embodied therewith, the program instructions being executable by a processor to perform a method comprising:
receiving a set of images, wherein the set of images includes differently exposed images of a scene recorded by a camera; and
processing the set of images by a trained neural network configured to perform one or more of: object detection, object classification and object recognition in image data, wherein the neural network uses image data from at least two differently exposed images in the set of images to detect objects in the set of images.
